(19) United States
(12) Patent Application Publication
(10) Pub. No.: US 2002/0109949 A1
(43) Pub. Date: Aug. 15, 2002

(54) Power supply system inside automobile

(75) Inventors: Hiroto Ueno, Nagoya-shi (JP); Naoya Kurimoto, Yokkaichi-shi (JP)

Correspondence Address: OLIFF & BERRIDGE, PLC, P.O. BOX 19928, ALEXANDRIA, VA, 22320, US

(73) Assignee: Autonetworks Technologies, Ltd., Nagoya-shi (JP)

(21) Appl. No.: 10/062,722

(22) Filed: Feb. 5, 2002

(30) Foreign Application Priority Data
Feb. 9, 2001 (JP) 2001-033526

(51) Int. Cl. H02H 3/00

(52) U.S. Cl. 361/2

(57) ABSTRACT

A connector C₀ is provided for a 42V battery B, a pair of housings of this connector C₀ are connected or disconnected by rotation of an arm, and when the arm rotates at a predetermined angle in a separating direction, a contact 24 separates from a contact of the arm. An ECU detects this separation and actuates a cut-off relay R thereby to shut off a power supply circuit S. Therefore, the connector C₀ is disconnected in a state where the electric current is not flowing, so that arc is not produced. Further, sub-connectors C₁ to Cₙ can adopt mechanism in which connection and disconnection are performed by the rotation of the arm similarly to the main connector C₀ thereby to cut off the electric current before the disconnection.

### BACKGROUND OF THE INVENTION

This invention relates to a power supply system inside an automobile in which a connector is provided in a power supply circuit inside an automobile and electric power can be supplied to loads or cut off by connection or disconnection of the connector.

An electric circuit inside an automobile is constituted by a wire harness, and its wire harness is connected through many connectors. In its electric circuit, under the state where the electric current is flowing, when the connector provided in its circuit is disconnected (removed) because of repair and maintenance, arc may be produced between terminals. The production of this arc may cause meltage of the terminal, and some bad influence may be given onto loads.

From viewpoints of safety and economy of automobile, there is a tendency to change its power supply circuit from a traditional 14V power system to a high voltage power supply system such as a 42V power system.

The higher a voltage of the electric circuit is, the more violently the above arc is produced, so that it is necessary to prevent the production of the arc.

### SUMMARY OF THE INVENTION

Under these circumstances, an object of this invention is to prevent the production of the above arc.

In order to achieve the above object, in this invention, before connection terminals in a connector are disconnected, connection of a power supply to its terminal is cut, and thereafter the connector is disconnected.

Since the electric current is not flowing in the terminals in the connector at the disconnecting time, the arc is not produced at the disconnecting time. Therefore, meltage of the terminal caused by disconnection of the connector and disadvantage of loads are not produced.

As a mode for carrying out the invention, in a power supply system inside automobile in which a connector is provided in a power supply circuit inside an automobile and electric power can be supplied to loads or cut off by connection or disconnection of the connector, such a constitution can be adopted that before connection terminals in the connector are disconnected, connection of a power supply to the terminal is cut, and there after the connector is disconnected.

Specifically, the connector is so constituted that a lever member is rotatably provided for one of a pair of connector housings; a member that fits to the lever member is provided for the other of them; and as the lever member rotates, a fitting point of the lever member and the fitting member approaches gradually a rotational center of the lever member, and then the both connector housings are connected and coupled to each other. In this connector, when the lever member rotates at a predetermined angle in a direction where the connection and coupling state of the connector housings is released, the connection of the power supply to the terminal is cut off. As more concrete constitution of the connector, the constitution described in the Unexamined Japanese Patent Application Publication No. Hei 4-56084 is adopted. In this case, a connector connection detecting circuit detects disconnection of the connection terminals in the connector, and shuts off a power supply circuit by its detection signal. It is good to perform this action by an ECU (electronic control unit).

However, control by the ECU is not limited to only the connector described in this Published Unexamined Patent Application. Namely, the ECU inside the automobile can detect disconnection of connection terminals in various connectors, and can shut off a power supply circuit to each connector by its detection signal.

The subjects of the above connector are all the connectors provided in the power supply circuit. In case of a connector that is nearest to a power supply such as a battery, power supply from its power supply to all the electric devices can be cut off by disconnection of the connection terminals in its connector. At this time, its connector can be provided for the battery.

### BRIEF DESCRIPTION OF THE DRAWINGS

FIG. 1 is a schematic circuit diagram in one embodiment.

FIG. 2 shows one example of a connector in the embodiment, and it is a sectional view in a fitting connection state of the connector.

FIG. 3 is a diagram showing the fitting connection of the connector.

FIG. 4A is a cut plan view of a connector housing on a male terminal side of the connector;

FIG. 4B is a front view of the connector housing in FIG. 4A;

FIG. 4C is a left side view of the connector housing in FIG. 4A.

FIG. 5A is a plan view of a connector housing on a female terminal side of the connector;

FIG. 5B is a front view of the connector housing in FIG. 5A;

FIG. 5C is a bottom view of the connector housing in FIG. 5A; FIG. 5D is a left side view of the connector housing in FIG. 5A;

FIG. 5E is a cut plan view of the connector housing in FIG. 5A.

FIG. 6 is a schematic circuit diagram in another embodiment.

### DETAILED DESCRIPTION OF THE PREFERRED EMBODIMENTS

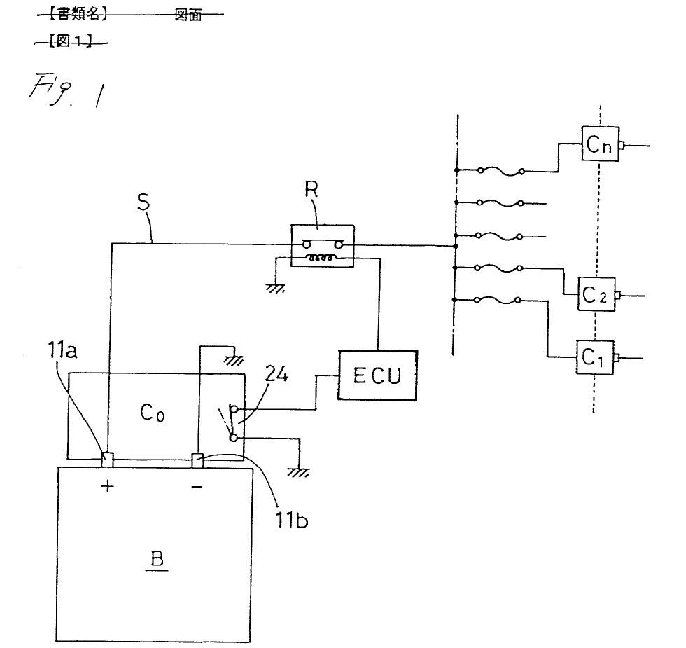

FIGS. 1 to 5 show one embodiment of the invention. In this embodiment, regarding an arc preventing system in a battery connector, a 42V battery B is used as a mounted battery, and a main connector C₀ is fixed to this battery B. In a power supply circuit S from this main connector C₀, acut-off relay R is provided and thereafter various loads (not shown) are connected through sub-connectors C₁ to Cₙ.

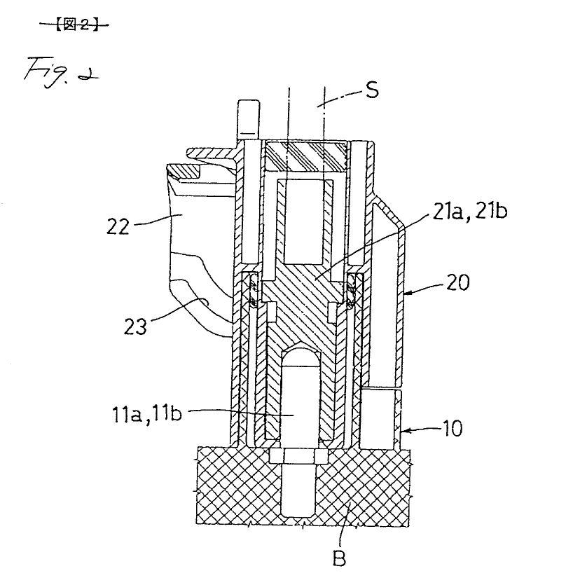

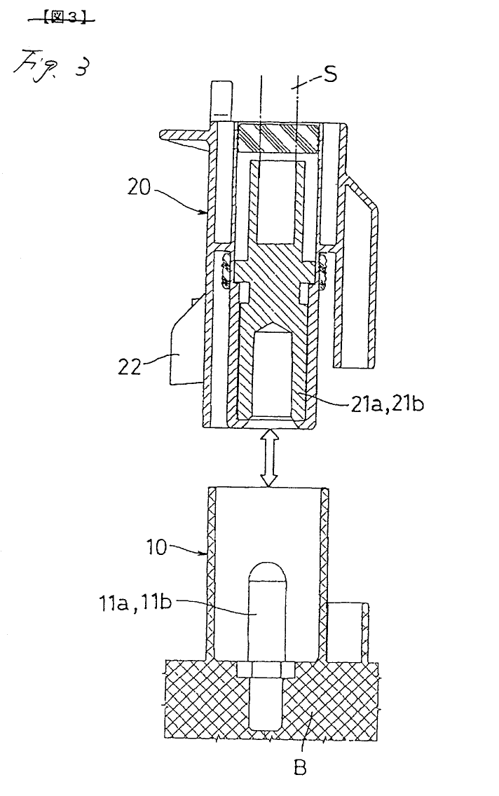

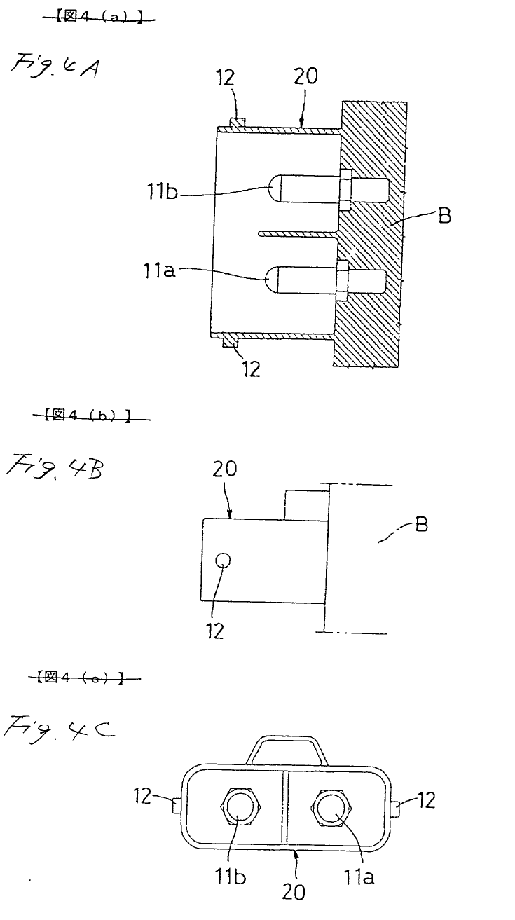

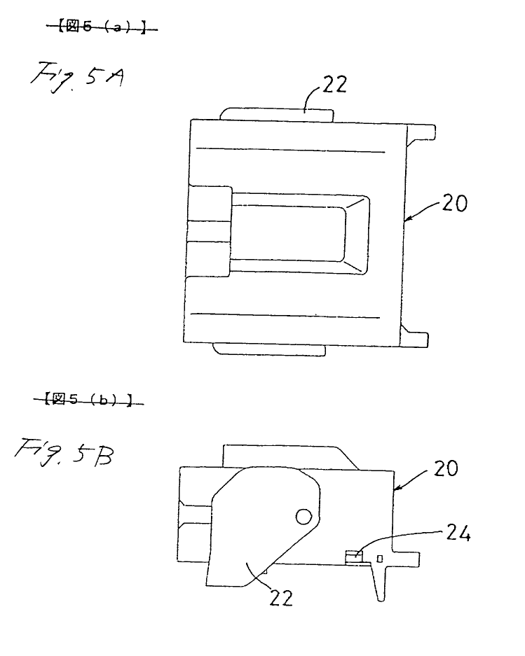

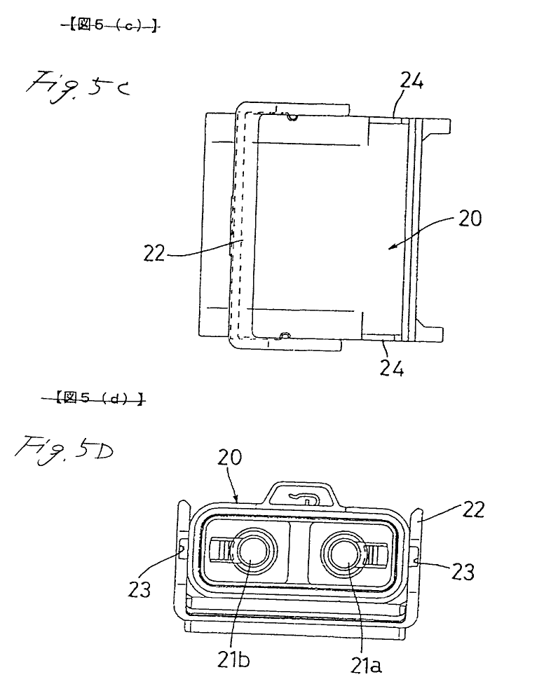

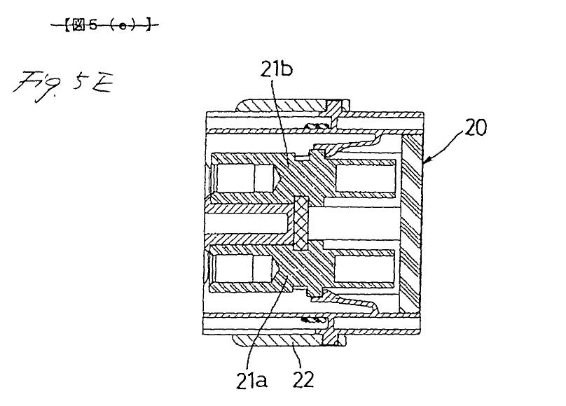

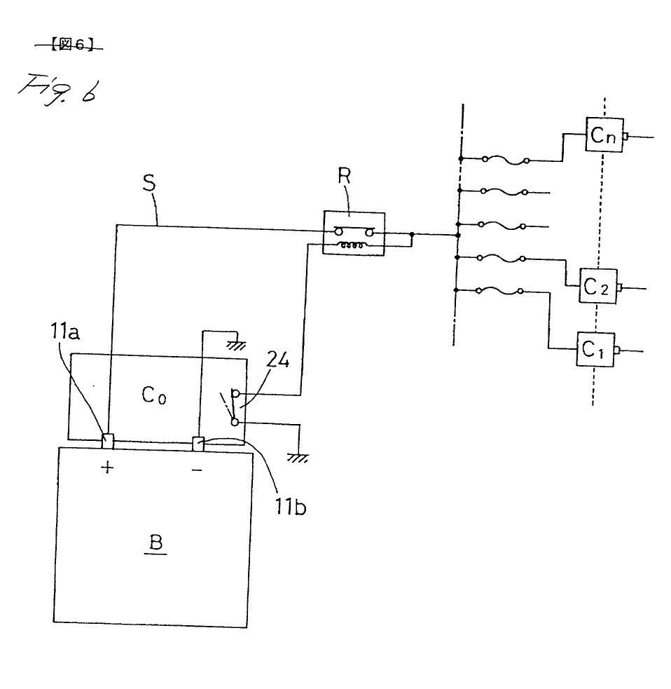

The main connector C₀, as shown in FIGS. 2 to 5, is composed of a pair of connector housings 10 and 20 similarly to the connector described in Published Unexamined Patent Application No. Hei 4-56084. One of them, the housing 10 is formed integrally with a case of the battery B and has positive and negative power supply terminals 11a, 11b of its battery (refer to FIG. 4A to 4C). The other housing 20, as shown in FIGS. 5A to 5E, has female terminals 21a, 21b therein, and an arm 22 functioning as a lever member is rotatably provided on an outer side surface of the housing 20. A groove 23 extending backward from a center of the front surface toward a rotational center is formed in a side portion of this arm 22. When the both housings 10, 20 are placed opposite to each other (from a state shown in FIG. 3 to a state shown in FIG. 2), a pin (fitting member) 12 on a side surface of one housing fits to its groove 23, and thereafter the arm 22 is rotated, the both housings 10, 20 approach each other while the pin 12 is sliding in the groove 23 with its rotation and fit to each other, so that the terminals 11a, 11b are fitted and connected to the terminals 21a, 21b (refer to FIG. 2 and the above Published Unexamined Patent Application) . When the arm 22 rotates at 90 degrees as shown in FIG. 2, its fitting connection is completed. On the other hand, until the arm 22 rotates reversely at about 90 degrees from this completion state, the both housings 10, 20 cannot be separated.

On both side surfaces of the other connector housing 20, contacts 24 are provided. When this contact 24 is covered with the arm 22, it comes into contact with a contact inside the arm (state shown by a solid line in FIG. 1 and state shown in FIG. 2). On the other hand, when the arm 22 rotates at about 20 degrees in the separating direction under the state where the fitting connection of the both housings 10, 20 is completed, covering of the contact 24 with the arm 22 is released, so that the contact 24 separates from the contact of the arm 22 (state shown by a chain line in FIG. 1). At this time, the rotation of the arm 22 does not give the separating operation to the both terminals 11a, 11b and 21a, 21b.

This contact 24 is connected to the ECU. The ECU, as soon as the contact 24 separates from the contact of the arm 22, detects this separation and actuates the cut-off relay R thereby to shut off a power supply circuit S. Therefore, when the arm 22 is further rotated to separate the both housings 10, 20 (when the connection of the both terminals 11a, 11b and 21a, 21b is cut off), its separation is performed in a state where the electric current is not flowing in the power supply circuit S, so that arc is not produced between the terminals 11a, 11b and the terminals 21a, 21b. In case that the contacts 24 are thus provided on the both side surfaces, the both contacts 24 are connected in series. The both contacts 24 come into contact with the contact of the arm 22, whereby completion of the fitting connection of the both housings 10, 20 is confirmed. The contact 24 may be provided on only one side surface. The rotational angle of the arm 22 at which the contact 24 separates from the contact of the arm 22 is arbitrary within a range where the ON/OFF (separation) operation can be performed surely.

In this embodiment, since the ECU controls the cut-off relay R, as long as the ECU makes the relay R off by off of an ignition thereby to cut off the power supply to each load and includes a collision sensor, the ECU can cut off the power supply to each load by making the relay R off on the basis of the detection signal, whereby it is possible to prevent disadvantage such as a fire of the load due to continuation of the power supply. Namely, according to various data that can be obtained, the ECU can make the relay R off and can suitably cut off the power supply to the load.

In case that the ECU is not used, as shown in FIG. 6, the contact 24 is connected directly to the cut-off relay R.

Also, for each sub-connector C₁ to Cₙ, mechanism that cuts off the power supply connected to the connectors C₁ to Cₙ on the basis of the separating operation may be provided similarly to the main connector C₀. In this case, the mechanism by the lever member similar to that in the above Published Unexamined Patent Application can be adopted.

As described above, according to the invention, before the connection terminals accommodated in the connector are disconnected, the connection of the power source to the terminal is cut off. Therefore, cutting-off of the terminal connection is performed in a state where the electric current is cut off, so that arc is not produced between the terminals, meltage of the terminal is not also produced, and disadvantage of the load is not also produced.

What is claimed is:

1. A power supply system inside automobile comprising:
a connector provided in a power supply circuit S inside an automobile, and
connection terminals for connecting or disconnecting so that loads is supplied by electric power or is cut off, wherein
before said connection terminals accommodated in said connector are disconnected, connection of a power supply to said connection terminal is cut off, and then said connector is disconnected.

2. The power supply system inside automobile according to claim 1, wherein
said connector is taken as a connector that is nearest to a power source B, and
by disconnecting said terminals in said connector, a power supply from said power source B to all electrical devices is cut off.

3. The power supply system inside automobile according to claim 2, wherein
said connector is provided for a battery B.

4. The power supply system inside automobile according to claim 1, wherein
a lever member 22 is rotatably provided for one of a pair of connector housings 10 and 20 of said connector;
a member 12 that fits to said lever member is provided for the other of said housings;
as said lever member 22 rotates, a fitting point of said lever member 22 and said fitting member 12 approaches gradually a rotational center of said lever member 22, and then said both connector housings 10 and 20 are connected to be coupled to each other; and
when said lever member 22 rotates at a predetermined angle in a direction where the connection and coupling state of said connector housings is released, the connection of said power supply to said terminal is cut off.

5. The power supply system inside automobile according to claim 1, wherein
disconnection of said connection terminals in said connector is detected by an ECU inside said automobile, and
said power supply circuit S is shut off by a signal of the detection.
